(19) United States
(12) Patent Application Publication
(10) Pub. No.: US 2016/0035301 A1
(43) Pub. Date: Feb. 4, 2016

(54) ACTIVE MATRIX DISPLAY WITH ADAPTIVE CHARGE SHARING

(71) Applicant: barnesandnoble.com llc, New York, NY (US)

(72) Inventor: Charles F. Neugebauer, Los Altos, CA (US)

(21) Appl. No.: 14/449,458

(22) Filed: Aug. 1, 2014

(51) Int. Cl. G09G 3/36

(52) U.S. Cl. CPC G09G 3/3648; G09G 2310/0286

(57) ABSTRACT

Techniques are disclosed for controlling an active matrix display using adaptive charge sharing. Separate voltages applied to each column control line correspond to the image data for setting the grayscale level of the respective pixels. Image data for one row of pixels are compared to the image data for another row of pixels on a column-by-column basis. If the image data for one or more columns changes from one row to the next by more than a threshold amount, charge sharing is activated between updating different rows for controlling the corresponding column control lines of the display. Charge sharing may be implemented by adding one or more capacitors that are switched with a block of column control lines, and a processor configured to compare the image data for successive rows, determine whether the criteria for charge sharing are met, and control the switches based on the determination.

### FIELD OF THE DISCLOSURE

This disclosure relates to the field of active matrix displays, and more particularly, to techniques for controlling an active matrix display using adaptive charge sharing.

### BACKGROUND

Active matrix displays, such as thin film transistor liquid crystal (TFT-LCD) displays, incorporate an array of picture elements, or pixels, which can be individually controlled to produce varying levels of light transmittance. The light transmittance, or so-called gray level, of each pixel is controlled by applying different voltages to the transistor. The pixels in most active matrix displays can be controlled on a row-by-row basis, which permits the use of one select line for each row of pixels and one control line for each column of pixels. As any given row is selected by a corresponding row control voltage, the gray level of each pixel in the selected row is controlled by applying an appropriate voltage to the corresponding column control line. Since some devices, particularly portable ones, may be powered by a battery, displays that are energy inefficient reduce the amount of operational time between battery replacements or recharges. To extend battery life, some prior solutions incorporate energy conserving techniques that are image independent. However, and as will be appreciated in light of this disclosure, these techniques are not optimized for certain image sequences, such as may occur on electronic book reading devices where the image is generally textual, and may therefore lead to excessive energy consumption. There remain other issues as well.

### BRIEF DESCRIPTION OF THE DRAWINGS

The accompanying drawings are not intended to be drawn to scale. In the drawings, each identical or nearly identical component that is illustrated in various figures is represented by a like numeral.

FIG. 1 is a block diagram illustrating an example active matrix display of an electronic computing device configured in accordance with an embodiment of the present invention.

FIG. 2 is a block diagram illustrating a portion of the example display of FIG. 1 configured in accordance with an embodiment.

FIG. 3 shows example voltages for driving a pixel of the example display of FIG. 1, in accordance with an embodiment.

FIG. 4 illustrates example input data for several columns of pixels, in accordance with an embodiment.

FIG. 5 is a flow diagram of an example process of controlling an active matrix display using adaptive charge sharing, in accordance with an embodiment.

### DETAILED DESCRIPTION

With battery powered devices in particular, it is desirable to reduce the rate at which the device consumes energy so as to extend the amount of time the device can operate on a single charge. Charge sharing is one technique that can be used to reduce the overall power consumption of an active matrix display. Charge sharing utilizes a charge pump to recycle energy that otherwise would be wasted during operation. A charge pump is a type of DC-to-DC converter that uses capacitors or inductors as storage elements to generate voltages that are higher or lower than provided by a power supply, such as a battery. For instance, a charge pump can multiply a source voltage by whole or fractional amounts as needed to produce a desired voltage level for a particular operation. The voltages produced by the charge pumps may, for example, be used to generate control signals for driving the pixels in each column of a display to a desired grayscale level. By temporarily storing at least some energy in the charge pump between pixel updates rather than discharging the energy to ground, less energy may be drawn from the power supply (e.g., battery) to drive the pixels to the desired voltage levels during each pixel update. However, the amount of energy consumed depends on the voltage levels used to update the pixels, which varies as a function of the image. Thus, in some cases, image-independent (e.g., continuous or non-adaptive) charge sharing may lead to little energy savings or energy loss. Prior charge sharing solutions utilize charge pumps between every pixel update without regard for the differential amounts of charge needed to drive nearby pixels. In this manner, energy efficiency can vary significantly as a function of the images being displayed.

To this end, and in accordance with an embodiment of the present invention, techniques are provided for controlling an active matrix display using adaptive charge sharing. The term “adaptive charge sharing” includes techniques where charge sharing is selectively activated on the basis of the image being displayed. In one specific embodiment, an active matrix display is formed by an array of pixels arranged in rows and columns. One frame (also referred to herein as an image) of a sequence of frames can be displayed by updating, or scanning, one row of pixels at a time based on image data received from an external source. The rows may be scanned consecutively (e.g., from the top of the display to the bottom) or in another sequence, such as even rows during one scan and odd rows during the next scan. Each pixel of the display can be individually controlled by applying control signals to the control lines of the respective row and column where the pixel lies. A voltage applied to a row control line selects pixels along the row for updating during a screen refresh, and separate voltages applied to each column control line correspond to the image data for setting the grayscale level of the respective pixels in the selected row. The image data for one row of pixels are compared to the image data for another row of pixels on a column-by-column basis. In accordance with an embodiment, if the image data for one or more columns changes from one row to another by more than a threshold amount, charge sharing is activated between updating different rows for controlling the corresponding column control lines of the display. Otherwise, charge sharing is not activated (e.g., the charge used to control the column control lines during a scan may not be recycled for the following scan). Charge sharing may be implemented, for example, by adding one or more capacitors that are switched with a block of column control lines, and a processor configured to compare the image data for successive rows, determine whether the criteria for charge sharing are met, and control the switches based on the determination. Numerous configurations and variations will be apparent in light of this disclosure.

As used herein, the term “frame,” in addition to its plain and ordinary meaning, includes the total amount of information presented on a display at a given time. For example, a frame may include data that represent all pixels of an image. Each successive row of a frame may include, to varying extents, the same or different data, depending on the image displayed.

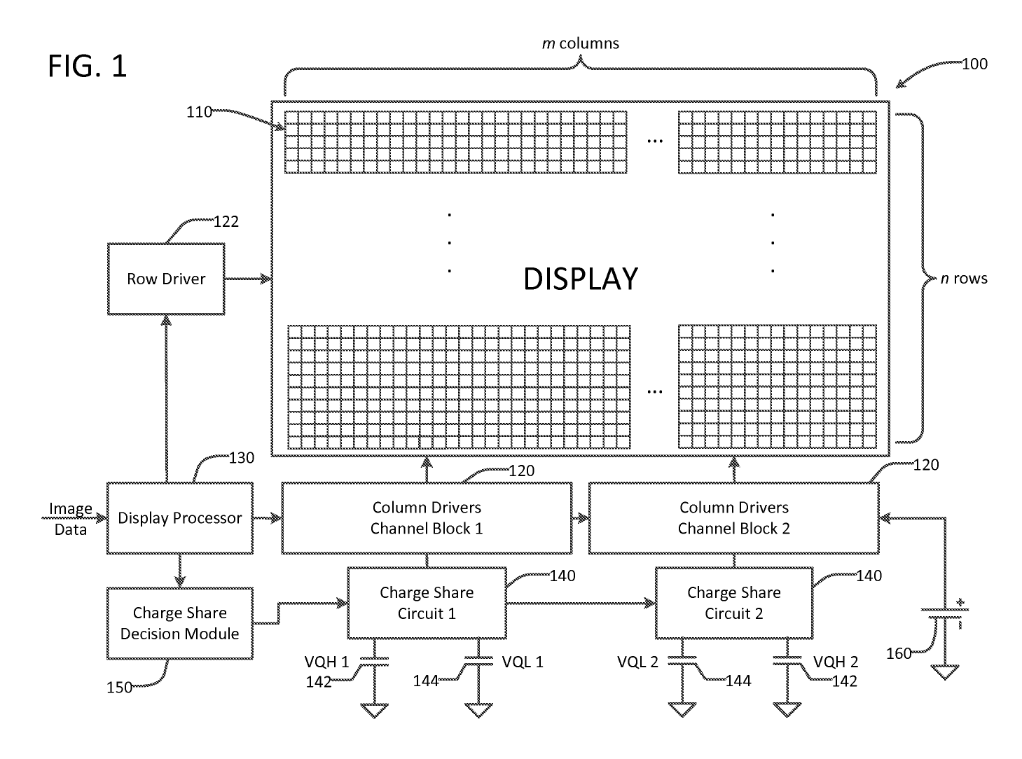

FIG. 1 is a block diagram illustrating an example active matrix display 100 configured in accordance with an embodiment of the present invention. The display may be included, for example, in a tablet computing device such as the NOOK® e-reader sold by Barnes & Noble, Inc. In a more general sense, the display may be included in any computing device capable of displaying digital content, such as a smart phone, e-reader, tablet computer, laptop, or desktop computer. The display includes an array of pixels generally indicated at 110 arranged in n rows and m columns. The columns of the array 110 are controlled by one or more column drivers 120, which may be configured to control blocks of columns by applying a voltage or signal to some of the pixels in the array 110. For example, one column driver 120 may be configured to control half of the pixel columns, and another column driver 120 may be configured to control the other half of the pixel columns. It will be understood that there may be any number of column drivers 120 each controlling any number of columns or a block of column channels of the pixel array 110. The rows of the array 110 may by controlled by one or more row drivers 122 for controlling the pixel rows. A display processor 130 is operatively connected to each of the column drivers 120 and row drivers 122 for providing image data to the display 100. The image data (e.g., an incoming DC voltage to the display processor 130) may be obtained from any suitable source (not shown), such as a memory, communications channel or another processor. The display processor 130 may include a DC-to-DC converter for receiving a DC voltage (e.g., representing the image data) from an external source and converting the DC voltage into an analog driving voltage for driving the column drivers 120, the row drivers 122, or both. The analog driving voltage may be used, for example, to generate a source voltage in the column drivers for driving the individual pixels in the array 110. Accordingly, the analog driving voltage effects the energy consumption of the display 100.

The device further includes one or more charge share circuits 140 each operatively connected to the column drivers 120, and at least two capacitors 142 and 144 (also referred to herein as VQH and VQL, respectively) each connected to one of the charge share circuits 140 and to an equipotential reference, such as ground. The device further includes a charge share decision module 150 operatively connected to each of the charge share circuits 140 and the display processor 130. The charge share decision module 150 is configured to analyze the incoming image data on, for example, a column-by-column basis. Based on the analysis, the charge share decision module 150 can control the charge share circuits 140 to activate charge sharing for a block of column channels using the capacitors 142 and 144. Each of the capacitors 142 and 144 is capable of storing different charges, such as three-quarters of the analog driving voltage (VQH) and one-quarter of the analog driving voltage (VQL), respectively. A power supply, such as battery 160, can be used to provide all or part of the analog driving voltage. In an example embodiment, charge sharing can be activated for a block of channels when the image data for at least one column of pixels meets one or more criteria, such as if the image data changes by more than a threshold amount from one row to another. For example, the threshold may be exceeded when the most significant bit of the image data for a column changes over two consecutive rows. In another example, the threshold may be exceeded when more than 50% of the bits of the image data for a column changes over two consecutive rows. Other charge sharing criteria, thresholds or forms of image data analysis are possible and will be apparent in view of this disclosure.

The display can be implemented, for example, with a 1920 by 1280 pixel LCD touch-sensitive display, or any other suitably-sized display. Any number of suitable form factors can be used, depending on the target application (e.g., laptop, smart phone, etc.). The device may, for example, be smaller for smartphone and e-reader applications and larger for tablet computer applications.

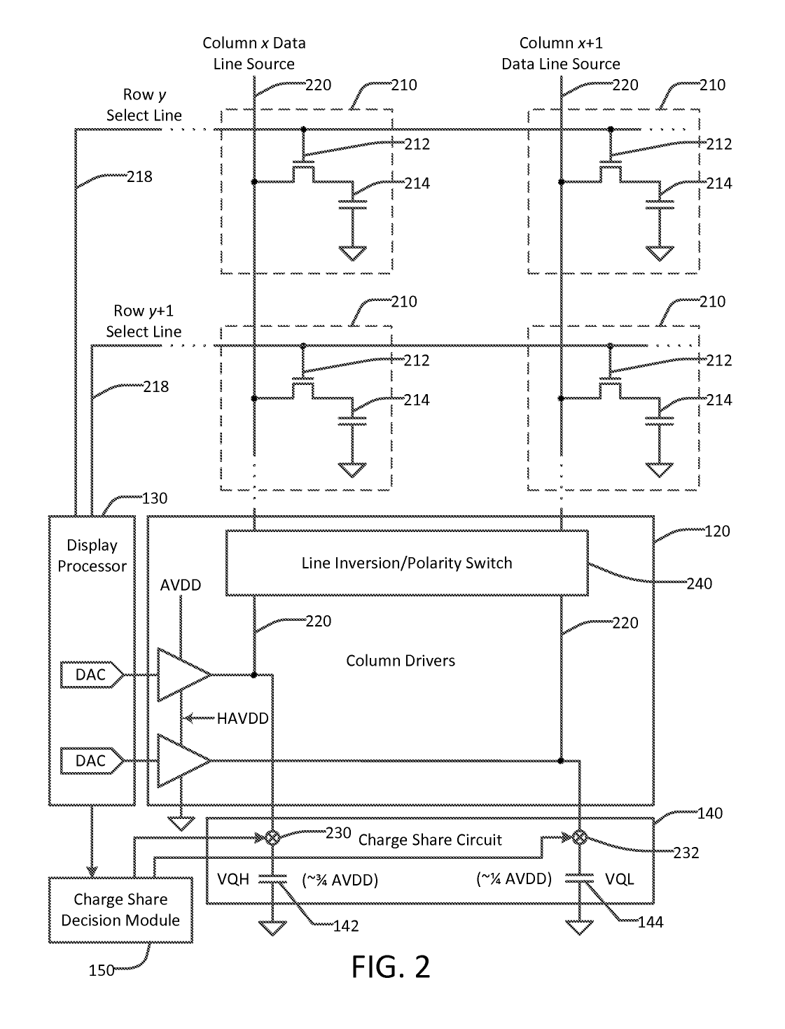

FIG. 2 is a block diagram illustrating a portion of the example display 100 of FIG. 1 in further detail, according to an embodiment. As discussed with respect to FIG. 1, the display 100 includes an array of n by m pixels 110. FIG. 2 depicts four such pixels 210 forming a portion of two consecutive columns (x and x+1) and two consecutive rows (y and y+1) of the array 110. Each pixel 210 includes a transistor 212 (e.g., a TFT transistor) having a gate coupled to a row select line 218 and a source coupled to a column data line 220, and a capacitor 214 coupled to the drain of the transistor 212 and an equipotential reference, such as ground. The pixel 210 may include additional or alternate components suitable for a specific application. As noted above, the charge share decision module 150 is operatively coupled to the charge share circuit 140. The charge share circuit 140 includes capacitors 142 and 144, as well as corresponding switches 230 and 232. The switches 230 and 232 can be controlled by the charge share decision module 150 to selectively connect and disconnect the capacitors 142 and 144 from the column control lines 220. For example, the switches 230 and 232 may be closed to activate charge sharing on the column control lines 220, and opened otherwise. It will be understood that only a portion of the charge share circuit 140 is shown in FIG. 2, and that similar elements can be used for each of the column drivers 120.

In each pixel 210, the gate of the transistor 212 is activated by a select voltage applied via the corresponding row select line 218. The pixel 210 is then switched on by a source voltage driven by the display processor 130 and applied to the transistor 212 via the corresponding column data line 220, which is provided by the column drivers 120. While the transistor 212 is activated, the source voltage is transferred to the capacitor 214 in the pixel, which maintains the source voltage for approximately the duration of a complete scan. The source voltage rotates the liquid crystals (not shown) in the pixel to different angles depending on the voltage level, which determines the light transmittance or gray level of the pixel. Color filters may be utilized to produce colored light of varying brightness. For instance, the pixel may include several separately controlled transistors (not shown) for producing different colors (e.g., red, green or blue) or combinations of colors via multiple column data lines. In such cases, for example, where the display includes red, green and blue pixels at each row and column position, there may be multiple column control lines 220 for each color. Thus, a display having a color resolution of 1200 by 1920 pixels may have 1920 row control lines and 3600 column control lines (i.e., three colors per column of pixels). It will be understood that the display may have any number of row and column control lines without departing from the scope of the present disclosure. The column drivers 120 can, in some embodiments, include a line inversion or polarity switch 240 for driving the pixels 210 in an inversion pattern (e.g., reversing the polarity of the source voltage on alternate scans) to reduce polarization and the change of possible damage of the liquid crystals.

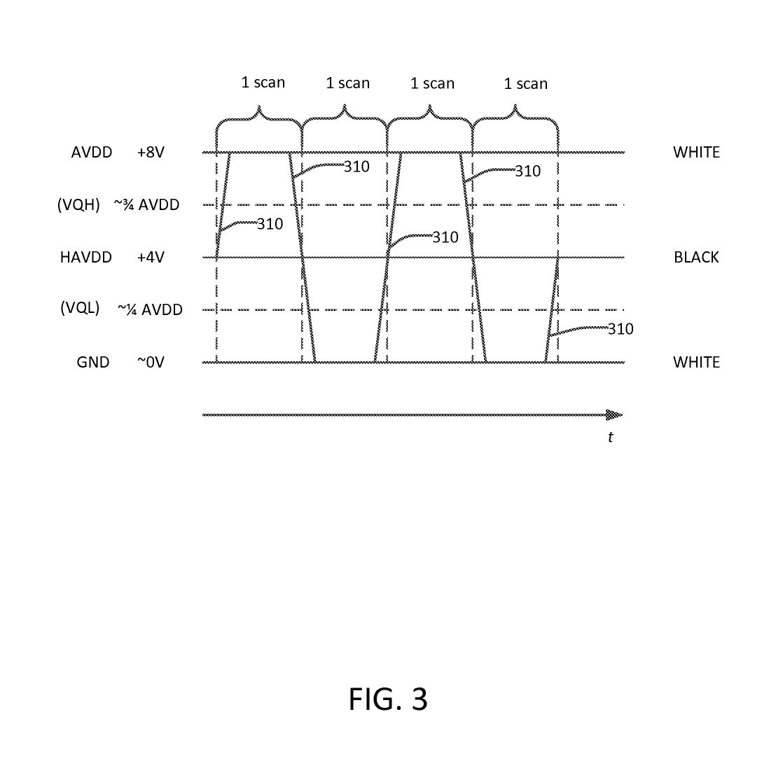

FIG. 3 shows example voltages for driving a pixel, such as pixel 210 of FIG. 2, over a period of time, according to an embodiment. As shown in FIG. 3, the output voltage for driving the pixel via a column control line can vary between an analog driving voltage AVDD (e.g., approximately 8 volts) and the equipotential reference (e.g., approximately zero volts). For example, the pixel may produce white while the pixel is driven to AVDD or zero volts, while black occurs when the source voltage is about one-half AVDD (HAVDD, e.g., 4 volts). Intermediate levels of gray may be obtained by applying voltages between HAVDD and AVDD or zero. In FIG. 3 an inversion pattern is shown by line 310, where the polarity of the source voltage alternates about HAVDD on successive scans to produce a continuously white pixel. It will be understood that other grayscale levels (including black) can be obtained by varying the column line voltage accordingly. For example, an intermediate gray level (approximately halfway between white and black) may be displayed by driving the pixel to VHQ or VHL, depending on the phase of the signal for a given scan. It will also be understood that patterns other than a line/dot inversion pattern may be used (e.g., pixel dot inversion, RGB sub-pixel dot inversion, line-paired pixel dot inversion, line-paired RGB sub-pixel dot inversion, or line-paired row-inversion). As will be apparent in light of this disclosure, if charge sharing is used for a block of column channels on a given scan, the capacitors 142, 144 can provide an intermediate voltage, such as VQH or VQL, to which the power supply (e.g., battery) contributes an additional charge, if any, to obtain the desired output voltage to drive the pixel. In this manner, the amount of energy drawn from the power supply can be reduced with respect to operating the device without charge sharing.

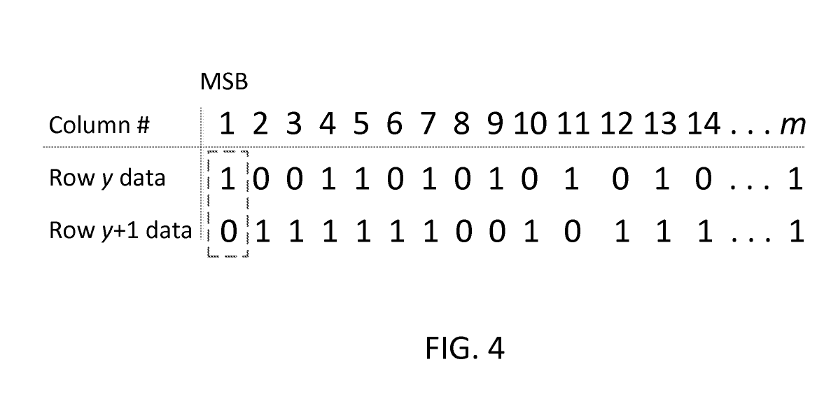

FIG. 4 illustrates a portion of example input data for m columns of pixels of a display, such as the display 100 of FIG. 1, for two successive rows y and y+1, according to an embodiment. For simplicity, each pixel is represented by a binary value 0 or 1, which may represent black and white or any two gray levels of the pixel. However, each pixel may be represented by other values (e.g., two or more bits of data) as necessary to represent more than two gray levels. In this example, the input data is depicted as being different for several columns over the two successive rows y and y+1, although it will be understood that the input data may be the same for two successive rows. The value of each bit in the input data causes the display processor 130 to drive the source voltage for the corresponding pixel (e.g., pixel 210 of FIG. 2) to an appropriate voltage level. For example, if the bit is 0, the source voltage may be driven to AVDD or GND, as shown in FIG. 3, and if the bit is 1, the source voltage may be driven to HAVDD.

In an embodiment, one or more bits of the input data for successive or different rows of the display are compared. For example, if the input data includes binary values for each pixel in each column, the most significant bit (MSB) (e.g., the binary value representing the first or last pixel in a given column, depending on how the data is organized) of the input data for two successive rows y and y+1 may be compared. If the MSB of the input data changes for the rows, charge sharing can be activated for driving one or more pixels in the column between updates of the rows y and y+1. In another example, if a certain number (e.g., 960) or percentage (e.g., 50%) of the bits of the input data change for the rows, charge sharing can be activated.

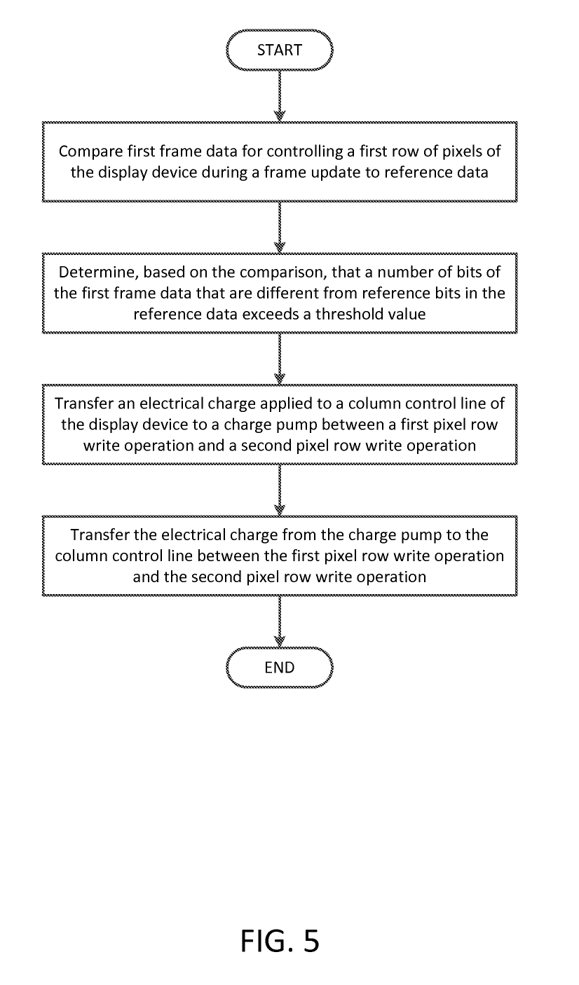

FIG. 5 is a flow diagram of an example process of controlling an active matrix display using adaptive charge sharing, in accordance with an embodiment. The process begins by comparing first frame data to reference data. The first frame data may, for example, be used to control a row of pixels of the display device during a frame update, such as discussed above with respect to FIG. 4. In some embodiments, the reference data includes second frame data for controlling a different row of pixels (e.g., an adjacent row) during the same frame update. In some other embodiments, the reference data includes data stored in a linear feedback shift register (LFSR). The LFSR may include any type of shift register and the shift register may be incremented, for example, between row or frame updates or at any other suitable time. Depending on the form of the reference data, a determination can be made based on the comparison that a criterion for charge sharing has been met, such as if number of bits of the first frame data that are different from reference bits in the reference data exceeds a threshold value. The threshold value can be any suitable value for determining whether or not to activate charge sharing for a particular pixel update. For example, if the comparison includes comparing a most significant bit of the first frame data to a most significant bit of the reference data, the threshold value may be zero (i.e., a difference in the most significant bits exists). In another example, the threshold value may be 50% of the bits in the first frame data (i.e., more than half of the bits are different).

If it is determined that the number of bits of the first frame data that are different from reference bits in the reference data exceeds the threshold value, the process continues by transferring an electrical charge applied to a column control line of the display device to a charge pump between a first pixel row update operation and a second pixel row update operation, which is sometimes referred to as the horizontal period of the scan. For example, if the number of bits that change in the frame data over two successive rows, or are different from bits in the LFSR, exceeds the threshold value (e.g., one bit for a MSB or LFSR comparison, or 50% of the bits), charge sharing may be activated for the column channel block by closing switches 230, 232, or both of FIG. 2. In this case, the source voltage applied to the column control line 220 is first connected to one of the capacitors 142, 144 prior to the transition from selecting one row to the next (or a different row if the rows are not scanned sequentially), such that the charge on the column control line can drain into the respective capacitor 142, 144, where it is temporarily stored at an intermediate voltage (e.g., VQH or VQL). The intermediate voltage may be, for example, approximately one-quarter or three-quarters of a full source voltage applied to the column control lines. After the charge is stored, the capacitors 142, 144 can be disconnected and any residual charge on the column control line 220 may be drained off to the equipotential reference level (e.g., ground).

The process further includes transferring the electrical charge from the charge pump to the column control line between the first pixel row update operation and the second pixel row update operation. For example, the column control line 220 is charged up to the source voltage corresponding to the image data for pixel in the next row of the column. The column control line 220 is first connected to one of the capacitors 142 or 144 so that the charge stored at the intermediate voltage in the capacitor (e.g., VQH or VQL) can flow to the column control line. Energy for completing the difference between the intermediate voltage and the source voltage for driving the pixel to the corresponding grayscale level for the image can be obtained from the power supply (e.g., the battery). In this manner, only the difference in voltage between the intermediate voltage and the source voltage need be obtained from the power supply, thus reducing the amount of energy drawn from the power supply.

Numerous embodiments will be apparent in light of the present disclosure, and features described herein can be combined in any number of configurations. In one example embodiment, a method of controlling a display device having pixels arranged in rows and columns is provided. The method comprises comparing first frame data for controlling a first row of pixels of the display device to reference data; determining, based on the comparison, that a number of bits of the first frame data that are different from reference bits in the reference data exceeds a threshold value; and in response to the determination, transferring an electrical charge applied to a column control line of the display device to a charge pump between a first pixel row update operation and a second pixel row update operation. In some embodiments, the method includes transferring the electrical charge from the charge pump to the column control line between the first pixel row update operation and the second pixel row update operation. In some embodiments, the threshold value is zero, and the comparing includes comparing a most significant bit of the first frame data to a most significant bit of the reference data. In some embodiments, the threshold value is fifty percent of bits in the first frame data. In some embodiments, the reference data includes second frame data for controlling a second row of pixels of the display device. In some embodiments, the reference data is stored in a linear feedback shift register. In some embodiments, the electrical charge is approximately three-quarters of a source charge applied to the column control lines for driving a pixel. In some embodiments, the electrical charge is approximately one-quarter of a source charge applied to the column control lines for driving a pixel.

In another example embodiment, a circuit for controlling a display device having pixels arranged in rows and columns is provided. The circuit comprises a charge pump; a switch coupled to the charge pump; a column control line coupled to a column of pixels of the display device and the switch; and a charge share decision module operatively connected to the switch and configured to: compare first frame data for controlling a first row of pixels to reference data; determine, based on the comparison, that a number of bits of the first frame data that are different from reference bits in the reference data exceeds a threshold value; and in response to the determination, operate the switch so as to cause a transfer of an electrical charge applied to a column control line of the display device to the charge pump between a first pixel row update operation and a second pixel row update operation. In some embodiments, the charge pump comprises two capacitors each switchably coupled to the column control line via the switch. In some embodiments, the charge share decision module is further configured to operate the switch so as to cause a transfer of the electrical charge from the charge pump to the column control line between the first pixel row update operation and the second pixel row update operation. In some embodiments, the threshold value is zero, and the comparing includes comparing a most significant bit of the first frame data to a most significant bit of the reference data. In some embodiments, the threshold value is fifty percent of bits in the first frame data. In some embodiments, the reference data includes second frame data for controlling a second row of pixels of the display device. In some embodiments, the charge share decision module comprises a linear feedback shift register, and the reference data is stored in the linear feedback shift register. In some embodiments, the electrical charge is approximately three-quarters of a source charge applied to the column control lines for driving a pixel. In some embodiments, the electrical charge is approximately one-quarter of a source charge applied to the column control lines for driving a pixel. In some embodiments, a mobile computing device includes the example circuit described in this paragraph.

In another example embodiment, a method of controlling a display device having pixels arranged in rows and columns is provided. The method includes performing first and second pixel row update operations to update an image displayed by the display device, the first and second pixel row update operations each comprising applying an electrical charge to first and second pixels of the display device, respectively; determining that frame data for updating the image meets a criterion for activating charge sharing; and in response to the determination, transferring at least a portion of the electrical charge from the first pixel to a charge pump and subsequently transferring the electrical charge in the charge pump to the second pixel between the first and second pixel row update operations. In some embodiments, the method includes comparing one or more bits of the frame data to reference bits in reference data, where the determination is based at least in part on the comparison. In some embodiments, the charge pump is charged to an intermediate voltage between a first source voltage for driving the pixels to white and a second source voltage for driving the pixels to black.

The foregoing description and drawings of various embodiments are presented by way of example only. These examples are not intended to be exhaustive or to limit the invention to the precise forms disclosed. Numerous variations will be apparent in light of this disclosure. Alterations, modifications, and variations will readily occur to those skilled in the art and are intended to be within the scope of the invention as set forth in the claims.

What is claimed is:

1. A method of controlling a display device having pixels arranged in rows and columns, the method comprising:
comparing first frame data for controlling a first row of pixels of the display device to reference data;
determining, based on the comparison, that a number of bits of the first frame data that are different from reference bits in the reference data exceeds a threshold value; and
in response to the determination, transferring an electrical charge applied to a column control line of the display device to a charge pump between a first pixel row update operation and a second pixel row update operation.

2. The method of claim 1, further comprising transferring the electrical charge from the charge pump to the column control line between the first pixel row update operation and the second pixel row update operation.

3. The method of claim 1, wherein the threshold value is zero, and wherein the comparing includes comparing a most significant bit of the first frame data to a most significant bit of the reference data.

4. The method of claim 1, wherein the threshold value is fifty percent of bits in the first frame data.

5. The method of claim 1, wherein the reference data includes second frame data for controlling a second row of pixels of the display device.

6. The method of claim 1, wherein the reference data is stored in a linear feedback shift register.

7. The method of claim 1, wherein the electrical charge is approximately three-quarters of a source charge applied to the column control lines for driving a pixel.

8. The method of claim 1, wherein the electrical charge is approximately one-quarter of a source charge applied to the column control lines for driving a pixel.

9. A circuit for controlling a display device having pixels arranged in rows and columns, the circuit comprising:
a charge pump;
a switch coupled to the charge pump;
a column control line coupled to a column of pixels of the display device and the switch; and
a charge share decision module operatively connected to the switch and configured to:
compare first frame data for controlling a first row of pixels to reference data;
determine, based on the comparison, that a number of bits of the first frame data that are different from reference bits in the reference data exceeds a threshold value; and
in response to the determination, operate the switch so as to cause a transfer of an electrical charge applied to a column control line of the display device to the charge pump between a first pixel row update operation and a second pixel row update operation.

10. The circuit of claim 9, wherein the charge pump comprises two capacitors each switchably coupled to the column control line via the switch.

11. The circuit of claim 9, wherein the charge share decision module is further configured to operate the switch so as to cause a transfer of the electrical charge from the charge pump to the column control line between the first pixel row update operation and the second pixel row update operation.

12. The circuit of claim 9, wherein the threshold value is zero, and wherein the comparing includes comparing a most significant bit of the first frame data to a most significant bit of the reference data.

13. The circuit of claim 9, wherein the threshold value is fifty percent of bits in the first frame data.

14. The circuit of claim 9, wherein the reference data includes second frame data for controlling a second row of pixels of the display device.

15. The circuit of claim 9, wherein the charge share decision module comprises a linear feedback shift register, and wherein the reference data is stored in the linear feedback shift register.

16. The circuit of claim 9, wherein the electrical charge is approximately three-quarters of a source charge applied to the column control lines for driving a pixel.

17. The circuit of claim 9, wherein the electrical charge is approximately one-quarter of a source charge applied to the column control lines for driving a pixel.

18. A mobile computing device comprising the circuit of claim 9.

19. A method of controlling a display device having pixels arranged in rows and columns, the method comprising:
performing first and second pixel row update operations to update an image displayed by the display device, the first and second pixel row update operations each comprising applying an electrical charge to first and second pixels of the display device, respectively;
determining that frame data for updating the image meets a criterion for activating charge sharing; and
in response to the determination, transferring at least a portion of the electrical charge from the first pixel to a charge pump and subsequently transferring the electrical charge in the charge pump to the second pixel between the first and second pixel row update operations.

20. The method of claim 19, further comprising comparing one or more bits of the frame data to reference bits in reference data, wherein the determination is based at least in part on the comparison.

21. The method of claim 19, wherein the charge pump is charged to an intermediate voltage between a first source voltage for driving the pixels to white and a second source voltage for driving the pixels to black.
